(19) United States
(12) Patent Application Publication
(10) Pub. No.: US 2013/0083883 A1
(43) Pub. Date: Apr. 4, 2013

(54) POOL LEVEL INDICATION SYSTEM

(71) Applicant: Westinghouse Electric Company LLC, Cranberry Township, PA (US)

(72) Inventor: Richard Morris, East Granby, CT (US)

(73) Assignee: WESTINGHOUSE ELECTRIC COMPANY LLC, CRANBERRY TOWNSHIP, PA (US)

(21) Appl. No.: 13/624,999

(22) Filed: Sep. 24, 2012

Related U.S. Application Data
(60) Provisional application No. 61/542,927, filed on Oct. 4, 2011.

(51) Int. Cl. G21C 17/112

(52) U.S. Cl. 376/247

(57) ABSTRACT

A liquid level indication system that employs a plurality of heated thermocouples staggered at discrete elevations along a height of a liquid pool, whose outputs are respectively compared to the output of an unheated thermocouple positioned at one of the lower discrete elevations. A significant difference in the outputs of the heated and unheated thermocouples provides an indication of the liquid level.

### CROSS REFERENCE TO RELATED APPLICATION

This application claims priority under 35 U.S.C. §119(e) from U.S. Provisional Application Ser. No. 61/542,927, entitled POST-ACCIDENT QUALIFIED SPENT FUEL POOL LEVEL INDICATION SYSTEM, filed Oct. 4, 2011.

### BACKGROUND

1. Field

This invention relates generally to liquid level monitors and, more particularly, to a liquid level monitor that is particularly suitable for monitoring the level of water in a nuclear reactor spent fuel pool.

2. Related Art

Pressurized water nuclear reactors are typically refueled on an 18-month cycle. During the refueling process, a portion of the irradiated fuel assemblies within the core are removed and replaced with fresh fuel assemblies which are relocated around the core. The removed spent fuel assemblies are typically transferred under water to a separate building that houses a spent fuel pool in which these radioactive fuel assemblies are stored. The water in the spent fuel pool is deep enough to shield the radiation to an acceptable level and prevents the fuel rods within the fuel assemblies from reaching temperatures that could breach the cladding of the fuel rods which hermetically house the radioactive fuel material and fission products. Cooling continues at least until the decay heat within the fuel assemblies is brought down to a level where the temperature of the assemblies is acceptable for dry storage.

Events in Japan's Fukushima Daiichi nuclear power plant reinforced concerns of the possible consequences of a loss of power over an extended period to the systems that cool spent fuel pools. As the result of a tsunami there was a loss of off-site power which resulted in a station blackout period. The loss of power shut down the spent fuel pool cooling systems. The water in some of the spent fuel pools dissipated through vaporization and evaporation due to a rise in the temperature of the pools, heated by the highly radioactive spent fuel assemblies submerged therein. Without power for an extended period to pump replacement water into the pools the fuel assemblies could potentially become uncovered, which could, theoretically, raise the temperature of the fuel rods in those assemblies, possibly leading to a breach in the cladding of those fuel rods and possible escape of radioactivity into the environment.

The loss of power at the Japan's Fukushima Daiichi nuclear power plant also prevented emergency personnel from understanding the conditions at the spent fuel pools so that corrective action could be taken, preferably before conditions became critical.

Accordingly, it is an object of this invention to provide a spent fuel pool level monitor that can operate under extremely adverse conditions, requiring very little power, for extended periods.

It is a further object of this invention to provide such a monitor that can reliably provide a remote output from which the water level within the spent fuel pool can accurately be determined.

### SUMMARY

These and other objects are achieved by a nuclear spent fuel pool having a volume of water in which spent fuel nuclear fuel assemblies can be submerged, that includes a water level sensor having a plurality of heated thermocouples respectively supported at different elevations within the pool. Each heated thermocouple has a first electrical output representative of the temperature at the corresponding supported elevation. A heater is supplied for heating each of the heated thermocouples and means are provided for transporting the first electrical outputs to a remote shielded location for monitoring. A comparator compares the electrical outputs of adjacent thermocouples to identify the elevation of the water level of the pool.

In one embodiment, the nuclear spent fuel pool includes at least one unheated thermocouple supported at an elevation within the pool below a normal water level of the pool. The unheated thermocouple has a second electrical output representative of the temperature at the unheated thermocouple support elevation. Desirably, the elevation that the unheated thermocouple is supported at is at or below a lower elevation of the plurality of heated thermocouples and, preferably, is proximate an upper elevation of a fuel assembly when the fuel assembly is stored in the pool. The at least one unheated thermocouple may include a plurality of thermocouples respectively supported at different elevations within the pool and the elevations of at least some of the unheated thermocouples correspond to the elevations of the heated thermocouples.

In still another embodiment, the heated thermocouples at different elevations are circumferentially spaced around the pool. Alternately, at least some of the heated thermocouples supported at the same circumferential location share a common heater and may be enclosed within a common sheath. Additionally, the sensor may include a separator tube enclosing the heated thermocouples and a heater or an unheated thermocouple or both, at a same circumferential location around the pool with the inside of the separator tube in fluid communication with the water in the pool. Additionally, the invention contemplates, in general, a liquid level sensor having the foregoing characteristics.

### BRIEF DESCRIPTION OF THE DRAWINGS

A further understanding of the invention can be gained from the following description of the preferred embodiments when read in conjunction with the accompanying drawings in which:

FIG. 1 is a schematic view of a spent fuel building housing a spent fuel pool with two trains of pool level sensor assemblies disposed within the pool in accordance with one embodiment of this invention;

FIG. 2A is a schematic cross sectional view of one embodiment of the sensor assemblies illustrated in FIG. 1;

FIG. 2B is a schematic cross sectional view of another embodiment of the sensor assemblies illustrated in FIG. 1;

FIG. 3 is a schematic view of the sensor assembly illustrated in FIG. 2;

FIG. 4 is a schematic view of another embodiment of this invention; and

FIG. 5 is a schematic block view of an additional embodiment of this invention.

### DESCRIPTION OF THE PREFERRED EMBODIMENT

The concerns over the potential consequences of a station blackout resulting in a loss of cooling of the spent fuel pool over an extended period became reinforced after a tsunami disabled Japan's Fukushima Daiichi nuclear power plant. This invention presents a means of providing additional pathways for determining the status of the spent fuel pool so that corrective action can be planned and taken before circumstances become critical.

The spent fuel pool water level probe of this invention can be implemented in a number of different embodiments, but each relies upon the principal of deploying thermocouple junction sensors at a plurality of discreet elevations along the spent fuel pool and monitoring the difference between the electrical outputs of adjacent sensors to determine whether the water level is between sensor locations. A low grade heater is associated with at least some of the sensors and the coolant water within the spent fuel pool provides a large enough heat sink that the comparison of the outputs between adjacent submerged thermocouples does not show substantially a difference in temperature. When a sensor is not immersed in the coolant, the surrounding air acts as an insulator and the heated thermocouple surrounded by the air will reflect that, with a significantly increased temperature reading as compared to the submerged thermocouple adjacent its location. In another embodiment, an unheated thermocouple can be deployed at each monitored elevation as a reference and the output of the heated thermocouple compared to the output of the unheated thermocouple. The results should be substantially the same as long as the heated thermocouple is submerged. The combination of two thermocouples and at least one heater with the electrical lead wires associated with each may be housed in a corrosion-resistant metal tube such as 300 Stainless Steel Series, surrounded by inorganic insulation. One end of the sensor tube may be sealed with the welded blind cap while an electrical connector is terminated at the other end. Alternately, the individual thermocouples may be housed separately in respective sleeves with several individual thermocouple sensors packaged together in a corrosion-resistant outer tube that also contains the heater elements. Furthermore, especially for new plant construction, the sensors may be located individually around the spent fuel pool which would provide the plant with operational flexibility after the initial installation.

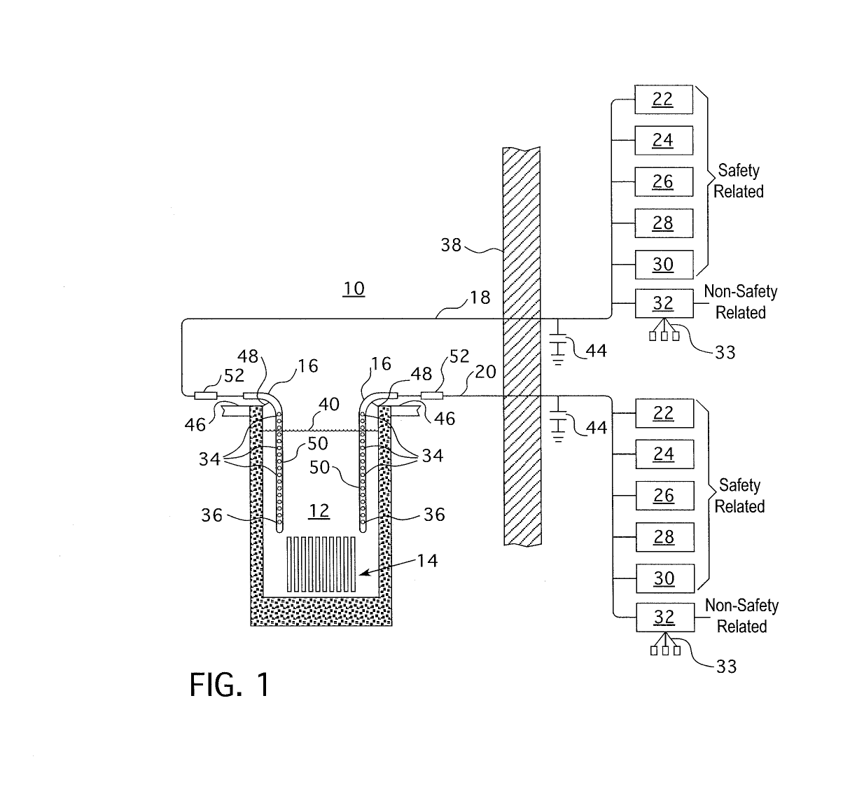

FIG. 1 is a schematic illustration of a spent fuel building 10 incorporating one embodiment of this invention deployed in a spent fuel pool 12 enclosed within the spent fuel building boundaries 38. A number of nuclear fuel assemblies 14 are shown submerged in the bottom of the spent fuel pool 12 with the pool water extending a sufficient distance to its upper surface 40 to shield the spent fuel assemblies 14 from an operating deck 46 above the spent fuel pool. In this embodiment, two spent fuel pool water level probes 16 are suspended from cantilevered brackets 48 and extend down into the pool 12 to an elevation that is preferably at or just above the upper level of the fuel assemblies 14. Each probe 16 is connected to a separate corresponding data train 18 and 20 to provide redundant outputs for an added measure of safety. Each water level probe 16 includes a number of heated thermocouple sensors 34 at discrete elevations along the probe with the lower elevation occupied by a reference unheated thermocouple probe 36, all enclosed within an outer sheath 50. Signals from the probes 16 are conveyed through electrical conductors along the redundant data trains 18 and 20 to monitoring locations on the operating deck 46 or through the building boundary 38 to a more remote shielded location such as the plant control room where the data communicated by the trains can be inputted to the safety related systems such as the Advanced Logic System 22, the Post Accident Monitoring System 24, the Inadequate Core Cooling Monitoring System 26, the Qualified Safety Parameters Display System 28 and the Spent Fuel Pool Information System 30. The information may also be inputted to the non-safety related systems such as a PC-based system 32 connected to the plant network 33 for information and appropriate action. Backup power is provided for the system in the event of a plant blackout through the batteries 44, an uninterrupted power supply or other auxiliary energy source, which are connected to the trains 18 and 20.

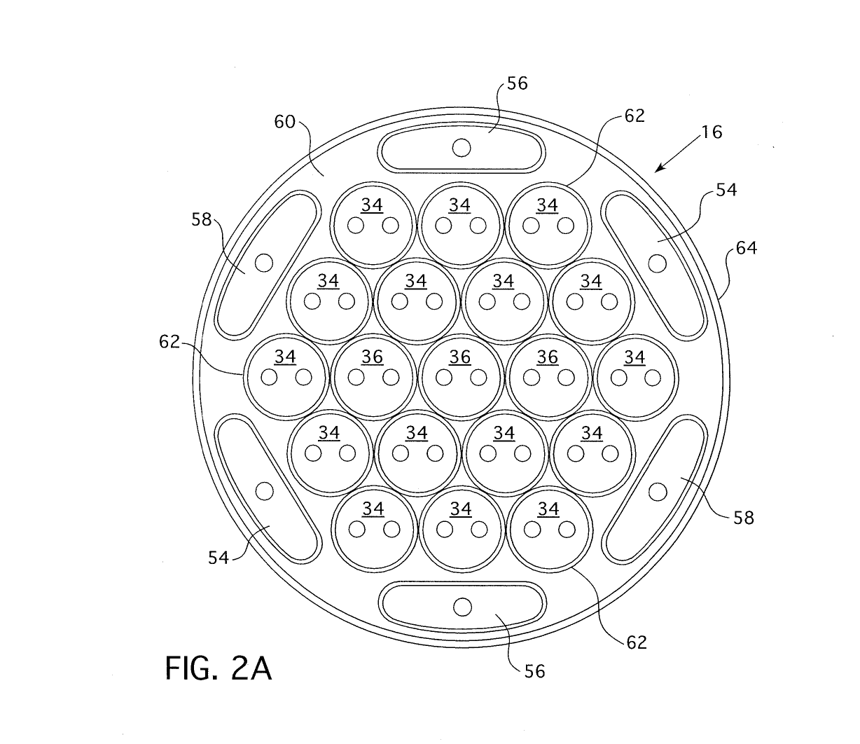

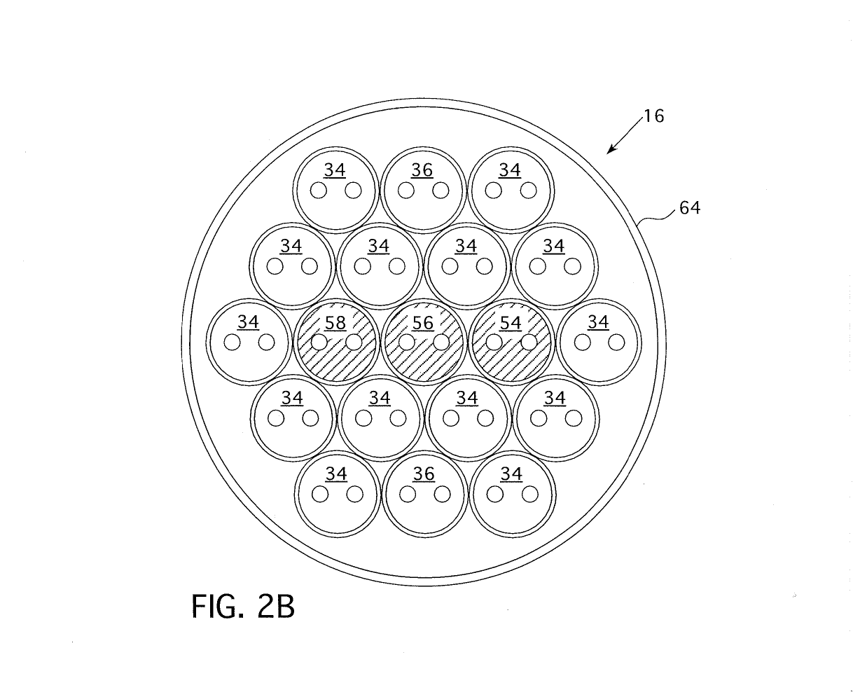

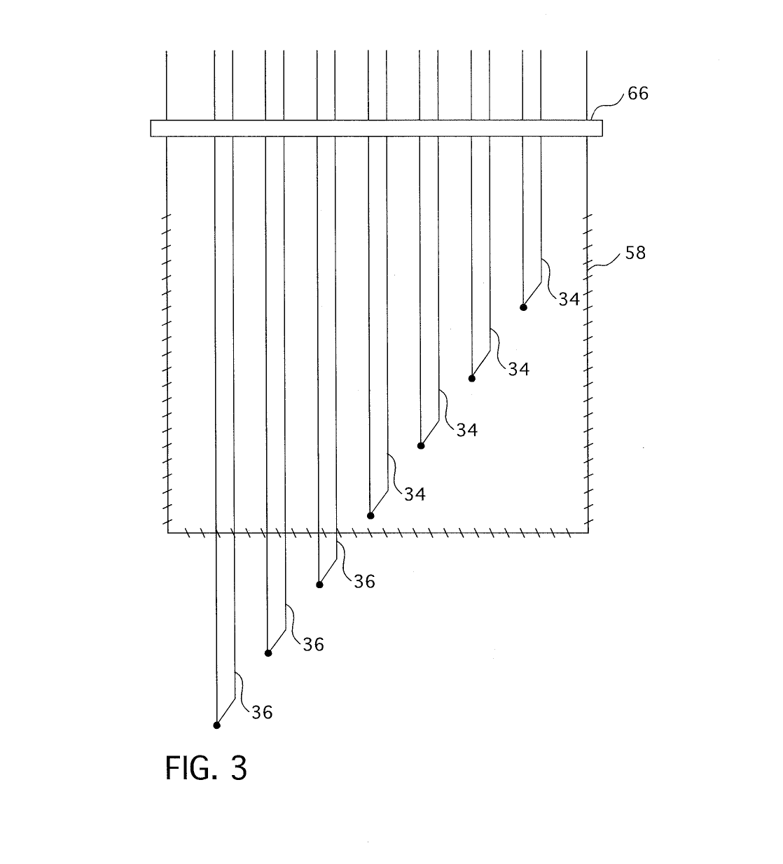

FIG. 2A shows a cross section of one embodiment of one of the probes 16. The spent fuel pool water level probe 16 shown in FIG. 2A includes sixteen heated probes 34 which extend down to different discrete elevations as shown in FIGS. 1 and 3. The installed sensor elevations and the number of sensors can be optimized based on plant requirements. The elevations of the vertical array of sensors can be staggered linearly throughout the depth of the spent fuel pool, or more preferably, the elevations of sensors will be distributed such that key or sensitive spent fuel pool levels, (e.g., nominal expected spent fuel pool level, top of the fuel assemblies, spent fuel pool overflow protection, etc.) have a higher density of sensors. It should also be appreciated that the number of sensors is directly proportional to the overall resolution of the system as well as total cost. Thus, while the embodiment illustrated in FIG. 2A shows 16 heated sensors the number may vary depending upon the application. In addition, the embodiment illustrated in FIG. 2A includes three unheated thermocouple sensors, for reference, though only one is required. The other two unheated thermocouple sensors provide redundancy and though, in FIG. 3, they are shown at three different elevations, the unheated sensors may alternately occupy the same elevation.

Each thermocouple consists of at least two conductors of different materials, such as the commonly used K-type thermocouple, that produce a voltage in the vicinity of the point where the two conductors (typically different metal alloys) are in contact. The voltage produced is dependent on, but not necessarily proportional to, the difference in temperature of the junction to other parts of those conductors. Thermocouples are a widely used type of temperature sensor for measurement and control that is quite rugged and inexpensive.

Each of the heated thermocouples 34 is heated by one or more of the heater filaments 54, 56 and 58 in the vicinity of its hot junction. Preferably, each hot junction of the heated thermocouple 34 is wrapped with more than one of the heater filaments for redundancy. Each of the individual thermocouples 34, 36 are preferably supported within their own individual sheaths 62 and each of the individual sheaths and the heater elements 58 are suspended within insulation 60 and enclosed within an outer sheath 64. FIG. 3 schematically shows the staggered positioning of the sensors though only four of the sixteen heated sensors 34 and only one of the three heater filaments, 58, are shown for simplicity.

FIG. 2B shows a cross section of another embodiment of one of the probes 16 that employs sixteen thermocouples; two unheated and fourteen heated. The two unheated thermocouples are shown positioned around the periphery of the assembly, though they could be placed at any of the remaining thermocouple positions because they extend down below the heater filaments as shown in FIG. 3. In this embodiment the heater filaments are centrally located and insulation can be inserted around the periphery of the thermocouple assembly, between the thermocouple assembly and the outer sheath 64.

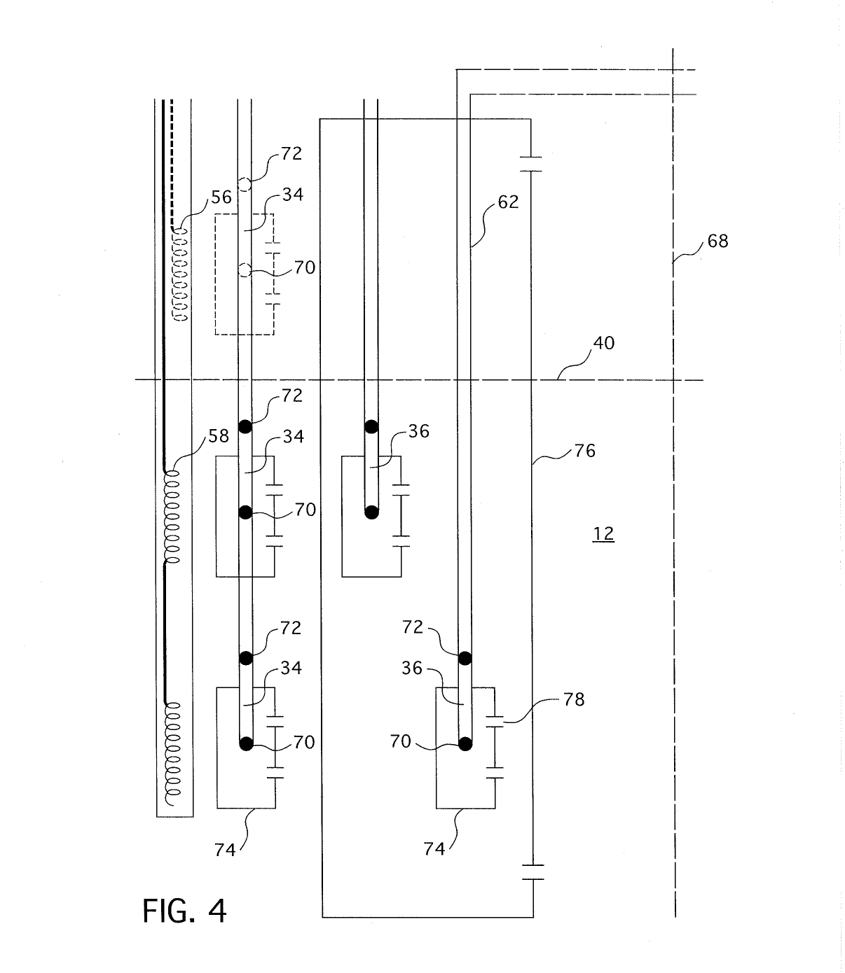

FIG. 4 illustrates another embodiment of this invention that employs a separate array of unheated thermocouples 36 that are supported at staggered elevations along the wall 68 of the spent fuel pool 12. Each of the thermocouples 36 has a hot junction 70 and a cold junction 72 to generate the output current that was previously noted. The hot junction 70 is enclosed within a splash guard 74 with openings 78 which isolate the hot junction 70 from turbulence and steam and air bubbles, to promote better heat transfer. The array of unheated thermocouples is further enclosed within a separator tube 76 that is in fluid communication with the spent fuel pool 12 at its lower end and with the environment above the spent fuel pool at its upper end for the same purpose. This embodiment also includes a tandem array of heated thermocouple sensors 34 that are heated by a filament coil 58 with each sensor 34 of the tandem array positioned at substantially the same elevation as a corresponding unheated thermocouple sensor 36. It should be appreciated that the heated array could be configured in the same staggered manner as the unheated array or, alternately, the unheated array can be supported in tandem like the heated array. While the embodiments illustrated in FIGS. 2 and 4 will each provide an indication of the level 40 of the spent fuel pool the embodiment illustrated in FIG. 4 will likely provide a more accurate result, however, at an added cost.

FIG. 4 also shows segmented effective length heater elements for extended system operation during loss of plant power conditions. In a traditional heater element the filament has a constant cross section. For example, if the string of thermocouples that forms the probe 16 is twenty feet long, the effective heater length is forty feet based upon the supply and return lines of the conductors; with the conductors having the same size diameter the entire length. However, the likely, relatively small rate of change in water level requires that the operator only focus on the thermocouples in close proximity to the water surface level as opposed to the thermocouples which are several yards above or below the water line. With a continuous heater, the entire twenty foot long instrument is heated and requires power when in effect you only need to have the few feet of interest above and below the water line being actively heated. This is a drain on the backup power sources under blackout conditions. Under such conditions a significant amount of the backup power is being wasted by heating a length of the probe that the operator has no present interest in. To minimize this drawback the heater element 58 shown in FIG. 4, while physically still traveling the exemplary forty feet *(twenty feet out and twenty feet back to form the loop), has a variable cross section, with a thicker cross section between thermocouple elevations and a thinner, higher resistance cross section at the heated thermocouple locations. The lengths of the heater circuit with the smaller diameter will offer resistance and function as a heater while other sections of the heater circuit will have a larger diameter and lower resistance that will simply pass the current without generating heat. It should also be appreciated that a similar result can be achieved by varying the resistance of the heater filament along its length by varying the composition of the wire filament. Preferably this concept is implemented employing a plurality of heater filaments, such as the two 56 and 58 shown in FIG. 4 or the three shown in FIGS. 2A and 2B so that each heater filament heats one half or one third of the probe length, as the case may be. The heater elements are individually controlled so the plant operator can selectively power the heater filaments adjacent the thermocouples on either side of the surface level and turn off the power to the other heater filaments during blackout conditions. This could offer a significant reduction in power consumption during backup powered operation while still providing the plant operator with excellent water level indication and trending. While two and three heater segments have been illustrated as exemplary of this invention additional segments can be employed without departing from the scope of the claims set forth hereafter.

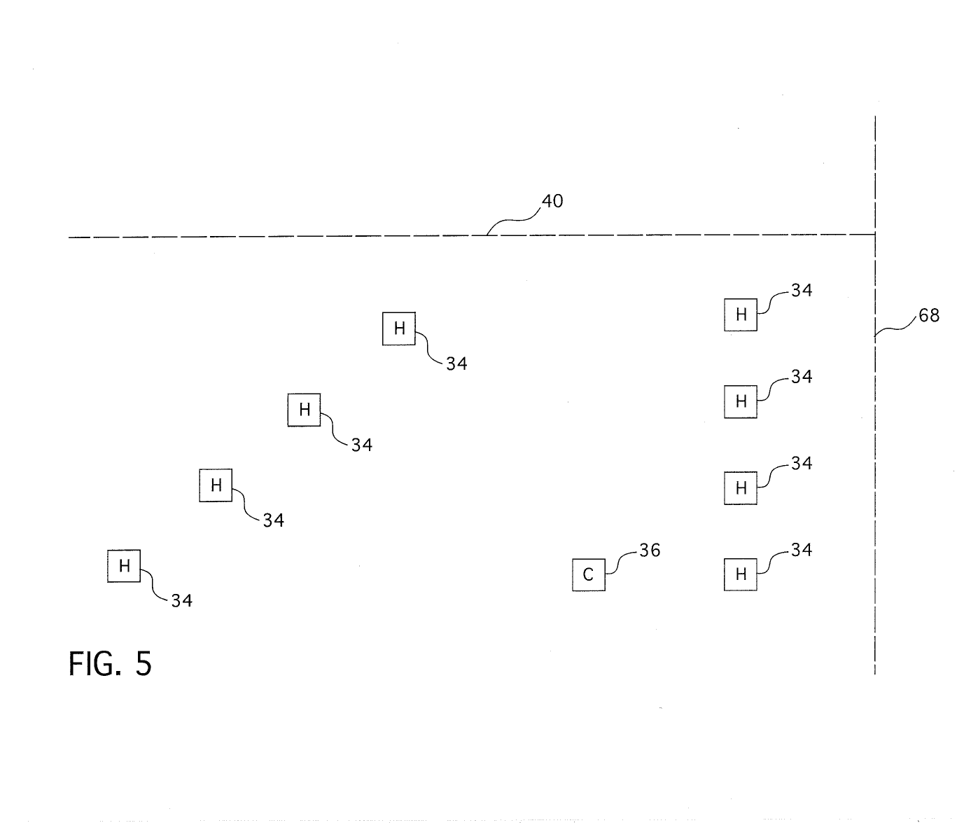

FIG. 5 shows an alternate embodiment that may be especially suitable for new construction. In this embodiment, the thermocouples are supported directly by the walls 68 of the spent fuel pool either in tandem or circumferentially spaced as their support location increases in elevation. This arrangement will give a better understanding of any dynamic motion within a pool. Furthermore, it should be appreciated that this invention can be used to monitor the liquid level of any fluid and is not limited to the surveillance of spent fuel pools.

As previously mentioned with regard to FIG. 1, each of the trains 18 and 20 has a battery backup 44, or other auxiliary energy source, that can be employed in the event of an emergency where there is a power blackout. The primary components requiring power are the heater filaments and the electrical current to the heater filaments can be significantly reduced to conserve the battery power for an extended outage without significantly impairing the system. The only thing that may be affected by the reduction in power is the response time. The thermocouple displays draw a minimal amount of power and can be operated intermittently to conserve power. Thus, the invention, as claimed hereafter, provides a relatively inexpensive solution to a serious problem of determining of what is happening in a spent fuel pool that was brought to light by the events at Fukushima Daiichi.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear spent fuel pool having a volume of water in which spent nuclear fuel assemblies can be submerged, including a water level sensor comprising:
a plurality of heated thermocouples respectively supported at different elevations within the pool, each heated thermocouple having a first electrical output representative of the temperature at the corresponding supported elevation;
a heater for heating the heated thermocouples;
means for transmitting the first electrical outputs to a remote shielded location for monitoring; and
a comparator for comparing the electrical outputs of adjacent thermocouples.

2. The nuclear spent fuel pool of claim 1 including at least one unheated thermocouple supported at an elevation within the pool at an elevation below a normal water level of the pool, the unheated thermocouple having a second electrical output representative of the temperature at the unheated thermocouple supported elevation.

3. The nuclear spent fuel pool of claim 2 wherein the elevation that the unheated thermocouple is supported at is at or below a lower elevation of the plurality of heated thermocouples.

4. The nuclear spent fuel pool of claim 3 wherein the elevation that the unheated thermocouple is supported at is proximate an upper elevation of a fuel assembly when the fuel assembly is stored in the pool.

5. The nuclear spent fuel pool of claim 2 wherein the at least one unheated thermocouple includes a plurality of thermocouples respectively supported at different elevations within the pool.

6. The nuclear spent fuel pool of claim 2 wherein the elevations of at least some of the unheated thermocouples correspond to the elevations of the heated thermocouples.

7. The nuclear spent fuel pool of claim 1 wherein the heated thermocouples at different elevations are circumferentially spaced around the pool.

8. The nuclear spent fuel pool of claim 1 wherein at least some of the heated thermocouples supported at substantially a same circumferential location share a common heater.

9. The nuclear spent fuel pool of claim 8 wherein the heater has a filament wire that extends along and between the at least some of the heated thermocouples that share the common heater wherein the filament wire has a larger electrical resistance over portions that extend along the at least some of the heated thermocouples than along portions of filament wire that extend between the at least some of the heated thermocouples.

10. The nuclear spent fuel pool of claim 9 wherein the at least some of the heated thermocouples supported at substantially the same circumferential location that share the common heater are supported at substantially adjacent elevations, including a second group of the heated thermocouples supported at substantially the same circumferential location and at a second set of substantially adjacent elevations, that share a second common heater, wherein the common heater and the second common heater are individually controlled.

11. The nuclear spent fuel pool of claim 1 wherein the heated thermocouples at a same circumferential location are enclosed within a common sheath.

12. The nuclear spent fuel pool of claim 1 including a separator tube enclosing the heated thermocouples and the unheated thermocouple at a same circumferential location around the pool with an inside of the separator tube in fluid communication with the water in the pool.

13. A liquid level sensor for monitoring a level of a liquid within a pool, the liquid level sensor comprising:
a plurality of heated thermocouples respectively supported at different elevations within the pool, each heated thermocouple having a first electrical output representative of the temperature at the corresponding supported elevation;
a heater for heating the heated thermocouples;
means for transmitting the first electrical outputs to a remote shielded location for monitoring; and
a comparator for comparing the electrical outputs of adjacent thermocouples.

14. The liquid level sensor of claim 13 including at least one unheated thermocouple supported at an elevation within the pool at an elevation below a normal water level of the pool, the unheated thermocouple having a second electrical output representative of the temperature at the unheated thermocouple supported elevation.

15. The liquid level sensor of claim 14 wherein the elevation that the unheated thermocouple is supported at is at or below a lower elevation of the plurality of heated thermocouples.

16. The liquid level sensor of claim 15 wherein the elevation that the unheated thermocouple is supported at is proximate an upper elevation of a fuel assembly when the fuel assembly is stored in the pool.

17. The liquid level sensor of claim 14 wherein the at least one unheated thermocouple includes a plurality of thermocouples respectively supported at different elevations within the pool.

18. The liquid level sensor of claim 14 wherein the elevations of at least some of the unheated thermocouples correspond to the elevations of the heated thermocouples.

19. The liquid level sensor of claim 13 wherein the heated thermocouples at different elevations are circumferentially spaced around the pool.

20. The liquid level sensor of claim 13 wherein at least some of the heated thermocouples supported at substantially a same circumferential location share a common heater.

21. The nuclear spent fuel pool of claim 20 wherein the heater has a filament wire that extends along and between the at least some of the heated thermocouples that share the common heater wherein the filament wire has a larger electrical resistance over portions that extend along the at least some of the heated thermocouples than along portions of filament wire that extend between the at least some of the heated thermocouples.

22. The nuclear spent fuel pool of claim 21 wherein the at least some of the heated thermocouples supported at substantially the same circumferential location that share the common heater are supported at substantially adjacent elevations, including a second group of the heated thermocouples supported at substantially the same circumferential location and at a second set of substantially adjacent elevations, that share a second common heater, wherein the common heater and the second common heater are individually controlled.

23. The liquid level sensor of claim 13 wherein the heated thermocouples at a same circumferential location are enclosed within a common sheath.

24. The liquid level sensor of claim 13 including a separator tube enclosing the heated thermocouples and the unheated thermocouple at a same circumferential location around the pool with an inside of the separator tube in fluid communication with the water in the pool.
